(19) United States
(12) Patent Application Publication
(10) Pub. No.: US 2011/0096354 A1
(43) Pub. Date: Apr. 28, 2011

(54) SYSTEM AND METHOD FOR HANDLING PRINT REQUESTS FROM A MOBILE DEVICE

(75) Inventor: Hua Liu, Fairport, NY (US)

(73) Assignee: Xerox Corporation, Norwalk, CT (US)

(21) Appl. No.: 12/603,999

(22) Filed: Oct. 22, 2009

(51) Int. Cl. G06F 15/00

(52) U.S. Cl. 358/1.15

(57) ABSTRACT

A method and system for a mobile device to submit a document for printing thereof are provided. A processing system includes a tangible processor and a software module executable by the tangible processor for receiving a print request from a mobile device to print a document. The tangible processor converts the document into a printer ready format and submits the document to a selected printer device of at least two printer devices that the tangible processor is in data communication with to for printing of the document, wherein the receiving, converting and submitting are performed without intervention by a user of the tangible processor.

### BACKGROUND

The present disclosure relates generally to a system and method for handling print requests from a mobile device. In particular, the present disclosure relates to a system and method for handling print requests from a mobile device in a network environment. Users of mobile devices, even when traveling and on-the-go, can often access documents, such as photographs or business related documents. There are occasions in which a user would like to produce a hard copy of a document by printing it. Traditionally, this would have to be done by numerous steps, including uploading the document to a computer that is interfaced with a printing device, accessing the document from the computer, and then requesting via the computer that a printer print the document.

### SUMMARY

The present disclosure is directed to a processing system for handling print requests from a mobile device. The system includes a tangible processor with a memory where the memory stores instructions to be executed by the tangible processor for receiving a print request from a mobile device to print a document and converting the document into a printer ready format. The instructions are further to be executed by the tangible processor for submitting the document to a selected one of at least two printer devices which are in data communication with the tangible processor for printing of the document, wherein the receiving, converting and submitting are performed without intervention by a user of the tangible processor.

The present disclosure is also directed to a method for a wireless mobile device to submit a document for printing thereof. The method includes receiving by a hardware processor a print request from a wireless mobile device to print a document. The method further includes converting by the hardware processor the document into a printer ready format, and submitting by the hardware processor the document to a selected printer device of at least two printer devices that the hardware processor is in data communication with for printing of the document, wherein the receiving, converting and submitting are performed without intervention by a user of the hardware processor.

The present disclosure is further directed to a wireless mobile device including a processor assembly including at least one hardware processor accessing at least one data storage device. The mobile device further includes a software module executable by the processor assembly for retrieving document information, including one of a document or an address for the document, from the accessible at least one storage device, selecting a printer device from a plurality of printer devices available for printing the document, and generating a print request to print the document, wherein the print request includes the document information and information identifying the selected printer device. The mobile device transmits the print request to a print request handler, upon which the document is printed by the selected printer device.

The present disclosure is still further directed to a computer-readable medium storing a series of programmable instructions configured for execution by at least one hardware processor for performing a method for submitting a document for printing thereof by a wireless mobile device. The method includes the steps of receiving a print request from a wireless mobile device to print a document, converting the document into a printer ready format, and submitting the document to a selected printer device of at least two printer devices for printing of the document, wherein the receiving, converting and submitting are performed without intervention by a user of the at least one hardware processor.

Other features of the presently disclosed system and method for printing from a mobile device will become apparent from the following detailed description, taken in conjunction with the accompanying drawings, which illustrate, by way of example, the presently disclosed system and method.

### BRIEF DESCRIPTION OF THE DRAWINGS

Various embodiments of the present disclosure will be described below with reference to the figures, wherein:

FIG. 1 is a block diagram of an exemplary network having a print request handler for print requests from mobile devices in accordance with the present disclosure;

FIG. 2 is a block diagram of software modules executed by a processing assembly of a mobile device in accordance with the present disclosure; and

FIG. 3 is a block diagram of software modules executed by a processor assembly of a print request handler in accordance with the present disclosure.

### DETAILED DESCRIPTION

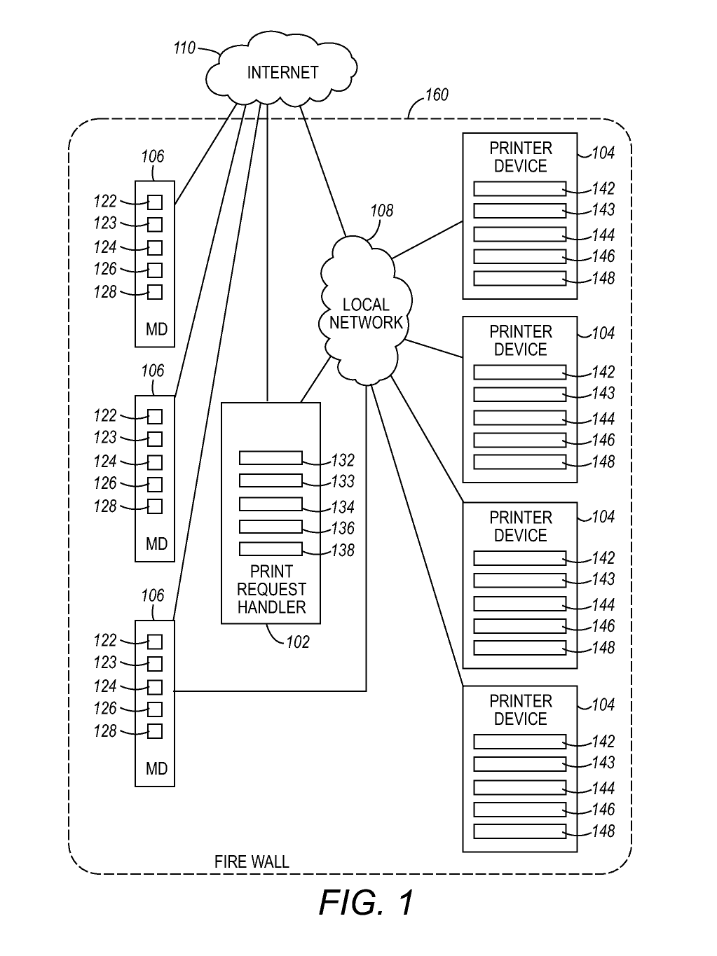

Referring now to the drawing figures, in which like reference numerals identify identical or corresponding elements, the system and method for handling print requests from mobile devices in accordance with the present disclosure will now be described in detail. With initial reference to FIG. 1, an exemplary network system in accordance with the present disclosure is illustrated and is designated generally as network system 100. Exemplary network system 100 includes a print request handler 102 in data communication (wired or wireless) with at least one printer device 104. At least one wireless mobile device 106 in data communication with the print request handler 102 for transmitting a print request to the print request handler, where the request is to print a document on one of the printer devices 104. The printer devices 104 are in data communication with the print request handler 102 via local network 108, and the mobile devices 106 communicate with the print request handler via wireless network 110 or via local network 108.

Each print request includes at least one document to be printed, and information that is needed for the print request to be executed, including, for example, printer information identifying a selected printer device 104 (e.g., printer ID, hostname, or IP address of the printer device 104) that the user has selected to print to, authentication information, print options information (e.g., specifying print options, such as, simplex or duplex, paper size and orientation, paper type, etc.), and/or user location information (e.g., the location of the user, e.g., using a room or building number or global positioning satellite (GPS) information that specifies the location). The document to be printed may be stored in a file, and is not limited to any specific genre of document. For example, the document may be an office document. a photograph, or a web page. An office document, for example includes a document produced by word processing software, spreadsheet software, presentation software (e.g., PowerPoint™), etc. The document may include a variety of types of data, including, for example, alphanumeric data, image data (e.g., photos, pictures, etc.), graphics (e.g., tables, charts, etc.). As described further below, a print request may be sent as an email, an FTP message, an HTTP message or a SOAP message. The SOAP message may include the binary data of or uniform resource locators (URLs) to the one or more documents to be printed, as well as authentication information, print options information, printer information and user location information.

The local network 108 includes hardware and software for coupling with devices, where the coupling is wired or wireless, and for supporting data communication between devices in data communication with the network. The local network 108 supports coupling of devices wherein first and second devices are coupled when they exchange data directly or indirectly via wired or wireless channels, where the exchange of data may be directly between the first and second device or may be via an intervening device. The local network 108 may include, for example, an intranet, a LAN, a WAN, Ethernet connections, Bluetooth connections, a wireless LAN (WLAN), a Wi-Fi network, a combination of the above, etc. The local network 108 may further provide wireless access, such as by including a wireless access point (WAP) or a wireless Ad-Hoc network, which allows the mobile devices 106 to communicate wirelessly with other devices in data communication with the local network 108, including the print request handler 102. The local network 108 may be included in an enterprise environment, include two or more sub-networks which are in data communication with one another. Each sub-network may include at least one node that is in data communication with the sub-network.

Network 110 is a network provided with wireless access via which the mobile devices 106 may access the print request handler 102. It may include, for example, the Internet, an intranet, a LAN, a WAN, Ethernet connections, Bluetooth connections, a wireless LAN (WLAN), a Wi-Fi network, a combination of the above, etc. The network 110 may further provide wireless access, such as by including a wireless access point (WAP) or a wireless Ad-Hoc network, which allows the mobile devices 106 to communicate wirelessly with other devices in data communication with the network 110, including the print request handler 102. The network 110 may include two or more sub-networks which are in data communication with one another. Each sub-network may include at least one node that is in data communication with the sub-network.

Network system 100 may include only one of networks 108 and 110 or may include both of them. For example, in one configuration, the mobile devices 106 may communicate with the print request handler 102 via network 110 embodied as the Internet using wireless access to the Internet, and the print request handler 102 communicates with the printer devices 104 via local network 108 embodied as a LAN. In another exemplary configuration, all of the communication between the mobile devices 106 and the print request handler 102 and all of the communication between the print request handler 102 and the printer devices 104 is via local network 108, which is configured, for example, as a LAN that includes wireless access, e.g., via a WAP.

The mobile devices 106 are mobile computing devices with wireless communication capability, such as a cellular phones, smart phones (e.g., a cellular phone that has increased computing and storage power relative to a conventional cellular phone, and further has internet access), personal digital assistants, and laptops. Each mobile device 106 includes a processor assembly 122 including at least one tangible hardware processing device (e.g., a microprocessor, an ASIC and/or a digital signal processor (DSP)) executing at least one software module. This may be configured as firmware. Each software module includes a series of programmable instructions capable of being executed by the processor assembly 122. The series of programmable instructions, stored on a computer-readable medium, such as at least one data storage device 123, are executed by the processor assembly 122 for performing the functions disclosed herein and to achieve a technical effect in accordance with the disclosure. The at least one storage device 123 (e.g., RAM, flash memory, etc.) is accessible by the processor assembly 122 for storing, accessing, and/or retrieving data and may be integrated with the mobile device 106, remote from the mobile device, or a combination thereof. The functions of the respective software modules may be combined into one module or distributed among a different combination of modules. The software module(s) are described in greater detail below.

The processor assembly 122 can access and retrieve data stored on the at least one storage device 123, including retrieving information or an address for the information, that is to be included in the print request. The information includes, for example, the document to be printed and authentication information. Some additional information to be included with the print request, such as the print options information and the user location information, may be generated at about the time that the print request is being formulated and may or may not be stored on the at least one storage device 123, and the storage may only be for a short period of time.

In a first embodiment of the mobile device 106, the print request may be transmitted to the print request handler 102 via email (in the body of an email message or as an email attachment). In second and third embodiments, respectively, of the mobile device 106, the print request is transmitted to the print request handler 102 via File Transfer Protocol (FTP) or Hypertext Transfer Protocol (HTTP) (which may be secured, e.g., HTTPs). In another variation, the print request may be transmitted to the print request handler 102 as a SOAP message that includes the binary data for or includes the URL to the documents to be printed as well as the authentication information, print options information, printer information and user location information. A software module that understands SOAP messages needs to be installed on the mobile device 106 in order for the mobile device 106 to generate the SOAP based print requests. Where the print request is sent via an email which the user manually formulates the email message (e.g., by manually including information related to the print request with the email message), the mobile device 106 does not require customized software modules to send the print request. Native software modules that are used to operate the mobile device 106 and provide email service are sufficient. If the print request is an email message in which print request related information is automatically included with the email message, or the print request is transmitted via FTP or HTTP(s), then software modules additional to the native software modules are needed for preparing the print request. These software modules are discussed further below.

Each mobile device 106 further includes a user output device 124 (e.g., an LCD or plasma display screen) for outputting information from the at least one processor assembly 122 to a user of the mobile device 106, and a user input device (UID) 126 (e.g., a touch screen, keypad, and/or rotary pad) for a user to provide input information to the at least one processor assembly 122. Each mobile device 106 may further be provided with at least one speaker, vibrator, microphone and/or radio capabilities for exchanging audio information with other mobile devices 106 and their users. Additionally, each mobile device 106 includes a wireless data communication module 128 which includes hardware and software as is known in the art for providing data communication with external processing devices, e.g., via the local network 108 and/or the Internet. The wireless communication is implemented, for example, via a wireless LAN (WLAN), a Wi-Fi network, fixed wireless data, a combination thereof, etc., which allows the mobile devices 106 to exchange data via their wireless communication modules 128 with the print request handler 102 when it is in data communication with network 108 and/or 110. The wireless data communication module 128 includes the necessary hardware and software to support data communication including at least one of sending emails with or without attachments to a remote receiver, transferring files to a remote receiver using FTP, and transferring files to a remote receiver using.

The mobile devices 106 may further be provided with means for acquiring an image of an optical code 129, such as a laser optical code reader or a camera (e.g., a conventional camera, such as those used with cellular phones) for acquiring an image of an optical code and/or an optical code decoder (described further below with respect to the software modules). The optical code reader 129 is operated by the mobile device user to acquire an image of a unique optical code associated with a selected printer device 104 that the user wants to print to. The optical code may be, for example, a QRcode or any other format of barcode.

The print request handler 102 includes a processor assembly 132 including at least one tangible hardware processing device (e.g., a microprocessor) executing at least one software module. Each software module includes a series of programmable instructions capable of being executed by the processor assembly 132. The series of programmable instructions, stored on a computer-readable medium, such as storage device 133, are executed by the processor assembly 132 for performing the functions disclosed herein and to achieve a technical effect in accordance with the disclosure. The at least one storage device 133 (e.g., RAM, flash memory, hard drive, external storage, such as CD-ROM, etc.) is accessible by the processor assembly 122 for storing, accessing, and/or retrieving data. The functions of the respective software modules may be combined into one module or distributed among a different combination of modules. The software module(s) are described in greater detail below.

The print request handler 102 includes first, second and/or third communication modules 134, 136, 138. First communication module 134 includes the hardware and software as is known in the art for providing data communication via local network 108, which may include, for example, the hardware and software needed for a wired coupling (e.g., via Ethernet) or a wireless coupling (e.g., via a wireless adapter) to the local network 108. Second communication module 136 includes the hardware and software as is known in the art for providing data communication via network 110, which may include, for example, the hardware and software needed for a wired coupling (e.g., via Ethernet) or a wireless coupling (e.g., via a wireless adapter) to the network 110. The second communication module 136, therefore, may provide a dedicated wired or wireless coupling to the Internet. Third communication module 138 includes the hardware and software for providing data communication with one or more printer devices 104, e.g., by coupling directly to a printer device 104, for example via a socket connection on the printer device 104, such as a communication port, e.g., TCP/IP port 9100, provided on the printer device 104. At least one of the first and second communication modules 134 and 136 supports data communication including at least one of receiving emails with or without attachments from a remote receiver, receiving files from a remote receiver using FTP, and receiving files from a remote receiver using HTTP/SOAP or other protocols.

With respect to the printer devices 104, the term “printer device” as used herein encompasses any apparatus or system, such as a digital copier, xerographic printing system, ink jet printing system, reprographic printing system, bookmaking machine, facsimile machine, multifunction machine, textile marking machine, etc., which performs a marking output function for any purpose. The modality for marking may include, for example, applying toner, ink, dye, etc., to the substrate or embossing, peening, etching, etc. the substrate. The substrate may be a material such as paper, cardboard, a transparency, a paper derivative, metal, plastic, glass, wood, cloth, etc.

The printer devices 104 each include at least one tangible hardware processing device 142 (e.g., a print controller, microprocessor, DSP, ASIC) executing at least one software module. This may be configured as firmware. Each software module includes a series of programmable instructions capable of being executed by the processing device 142. The series of programmable instructions, stored on a computer-readable medium, such as storage device 143, are executed by the processing device 142 for performing the functions disclosed herein and to achieve a technical effect in accordance with the disclosure. The at least one storage device 143 (e.g., RAM, flash memory, hard drive, external storage, such as CD-ROM, etc.) is accessible by the processor assembly 122 for storing, accessing, and/or retrieving data. The functions of the respective software modules may be combined into one module or distributed among a different combination of modules. The software module(s) are described in greater detail below.

The printer devices 104 each further include at least one communication module for receiving printer ready data files from the print request handler 102, such as a TCP/IP communication port 144 and a network interface 146. The communication port 144, includes hardware (e.g., TCP/IP port 9100), and software (e.g., an API) for providing data communication with the print request handler 102 (e.g., directly or via local network 108) for receiving the printer ready data documents. The network interface 146 is in data communication with network 108 or network 110 for receiving the printer ready data documents from the print request handler 102 via the network, e.g., for receiving SOAP messages using WS-Print protocols, or for receiving data streams using Line Printer Remote (LPR) printing protocols. This may include, for example, an Ethernet port and/or a USB port.

A firewall 160 is provided in association with the local network 108 for providing security to the local network 108, including excluding unauthorized access to the local network 108, protecting authorized communication conducted via the network 108 and preventing unauthorized access to the authorized communication. When a printer device 104 communicates with the print request handler 102 the communications are secured by the firewall 160. The firewall 160 may be provided via hardware, software or a combination thereof. When mobile device 106 is on the local network 108, e.g., via Wi-Fi, its communication may be secured by the firewall 160. However, the mobile device 106 can stay outside of the local network 108 and its communication with the print request handler 102 can be secured via secured channel e.g., HTTPs or via a registered user account.

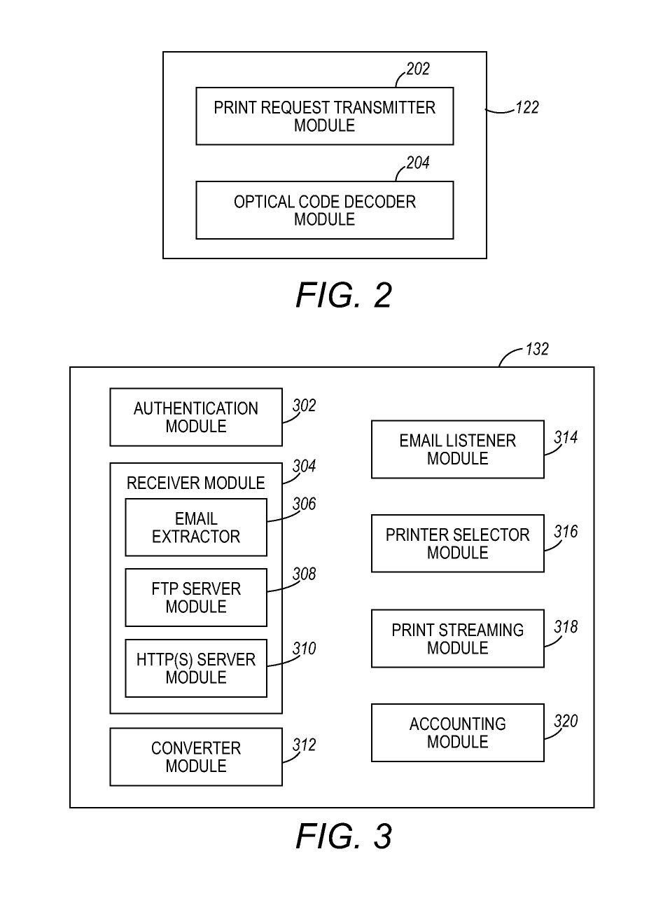

With respect to FIG. 2, the software modules executed by the processor assembly 122 of the mobile device 106 include a print request transmitter module 202 and/or an optional optical code decoder module 204. The print request transmitter module 202 transmits the print request, and further, depending on the embodiment used, may generate the print request that is to be transmitted. The optical code decoder module 204 decodes optical codes captured by the optical code reader and either provides the decoded code to the print request transmitter module 202 for inclusion in a print request, or stores the decoded code in a location on the at least one storage device 123 that can be retrieved by the print request transmitter module 202.

In the first embodiment of the mobile device 106, the mobile device 106 uses an email program to send the document to be printed to the print request handler 102 via email. The email program may be a native email program, and the user may manually generate an email that functions as the print request, including entering information into the email message by inserting information into the email message in selected fields and in a selected fashion. Alternatively, the print request transmitter module 202 may integrate with the email program to generate the print request email, including prompting the user to enter information, retrieving information and/or integrating entered or retrieved information into the email message by inserting it in selected fields and in a selected fashion. Additionally, the print request transmitter module 202 may integrate with other devices and/or software applications provided with the mobile device 106 or in data communication with the mobile device 106, such as the optional optical code decoder module 204 or a GPS application.

The document to be printed may be retrieved (by the print request transmitter module 202 or manually by the user) from the at least one storage device 123. The document is included in the body of the email or may be attached to the email. This can be done manually by the user or by the print request transmitter module 202. In addition, the email will include, either in its body or via attachments, information that is needed for the print request to be executed, including, for example, printer information, authentication information, print options information, and/or user location information. This information is retrieved from the at least one storage device 123 and entered into the email either manually by the user or by the print request transmitter module 202.

The printer information may be acquired in a variety of ways. For example, it may be manually entered, selected from a list of printers provided with the mobile device 106, provided by the optical code decoder module 204 that decodes an image acquired by the optical code reader 129. The optical code decoder module 204 receives an image of an acquired optical code, decodes the optical code, outputs optionally human readable printer information on the mobile device screen to the user and outputs a decoded printer identification code, which may be presented in a desired format that is expected by the print request handler 102 (e.g., string or integers). This information is inserted into the email message either automatically or manually by the user. The print request handler 102 may further access a database storing printer identification codes, where each printer identification code is associated with printer information such as a host name or an address, such as an IP address. The print request handler 102 retrieves printer information from the database that is associated with the decoded printer identification code.

In the second embodiment of the mobile device 106, the print request transmitter module 202 utilizes FTP to transmit the document that is to be printed. The print request transmitter module 202 interfaces with a native file handler or provides a file handler for accessing stored files and retrieving one or more documents selected by the user that are to be printed. The print request transmitter module 202 formulates print request to be transmitted by FTP, where the print request includes the document(s) to be printed, and information that is needed for the print request to be executed, including, for example, printer information identifying a selected printer device 104, authentication information, print options, and/or a location of the user. The formulating and transmitting of the print request may include using a commercially available FTP client software module.

The authentication information is retrieved, for example, from a location of the storage device 123 that is designated for authentication information, such as ID associated with the mobile device 106 or the user. Additionally, or alternatively, the print request transmitter module 202 may prompt the user, e.g., via a graphical user interface (GUI) displayed to the user, to enter authentication information, such as an ID and/or a password. The print request transmitter module 202 retrieves the input authentication information and includes it with the authentication information included in the message being formulated.

The printer information is in the same way as described above for the first embodiment The print request transmitter module 202 retrieves the user entered information and includes it with the printer information included in the message being formulated. The print options information may be user entered or default values may be used. The user location information may be user entered or provided by a location providing device, such as a GPS device which may be interfaced to or integrated with the mobile device 106. The print request transmitter module 202 formulates the print request with the above information and then transmits the print request using FTP.

In the third embodiment of the mobile device 106, the print request transmitter module 202 utilizes HTTP(s) to transmit the document that is to be printed. The print request transmitter module 202 may provide for the mobile device 106 to access a webpage or a website provided by the print request handler 102. For example, the print request transmitter module 202 may provide an icon or other link that the mobile device user can activate to access the website. The user may enter the print request using the website and prompts or user entry fields provided by the website. In order to submit the document to be printed with the print request, the print request transmitter module 202 interfaces with a native file handler or provides a file handler for accessing stored files and retrieving one or more documents selected by the user that are to be printed. For example, the native file handler may be used to upload the document to the website.

The print request may also be generated as an HTTP(s) message without accessing a website. Here, the print request transmitter module 202 retrieves stored authentication information, printer information identifying a printer selected by the user, print options information and/or user location information and formulates a print request that is an HTTP(s) compatible message. The formulating and transmitting of the print request may include using a commercially available HTTP client software module.

The authentication information, printer information, print options information and user location information are retrieved in substantially the same way as described above for the second embodiment. The print request transmitter module 202 includes the retrieved authentication information and printer information in the message being formulated. The print request transmitter module 202 then transmits the formulated message as the print request using HTTP(s). In the first, second or third embodiments, the print request may be encrypted for additional security purposes before transmission.

With respect to FIG. 3, the software modules executed by the processor assembly 132 of the print request handler 102 include a user authentication module 302, a receiver module 304, a converter module 312, an optional print selector module 316, a print streaming module 320, and an accounting module 322.

The user authentication module 302 manages user registration and authentication. A user of a mobile device 106 or the mobile device 106 must be registered with the print request handler 102 prior to using the services of the print request handler 102 for printing documents. Registering includes providing information to the authentication module that identifies the user or the user's mobile device 106. Registration may be performed, for example, by the user or an administrator at a device that is in data communication with the print request handler, has a processor that executes or accesses a registration program that provides entered registration information to the authentication module 302, and has means for the user or administrator to enter registration information. For example, registration may be performed at the print request handler 102 itself or at a computer terminal (not shown) that is in data communication with the print request handler 102 or at the user's mobile device 106. The authentication module 302 stores the entered registration information for the purposes of future authentication of a print request.

Each print request submitted by a mobile device 106 to the print request handler is accompanied by authentication information that identifies the registered mobile device 106 or user. The authentication module 302 authenticates the authentication information by comparing it with stored registration information. The authentication procedure may further require additional security measures, such as password verification or successful decryption of an encrypted print request.

In another embodiment, the authorization information may not be provided with the print request and the authorization module 302 may request the information from the mobile device 106 or from the user of the mobile device 106. This interaction between the authorization module 302 and the mobile device 106 may be transparent to the user of the mobile device 106.

The receiver module 304 receives the print request, extracts or retrieves the document to be printed from the request and extracts or retrieves printer information from the print request. The receiver module may include a decryption module may for decrypting any encrypted messages or files, whether received as emails or FTP or HTTP(s) transmissions. The receiver module 304 includes an email listener/extractor 306, an FTP server module 308, an HTTP(s) server module 310, or a combination thereof. The email listener/extractor 306, an FTP server module 308, an HTTP(s) server module 310 are configured, respectively, to operate with the first, second and third embodiments of the mobile devices 106.

The email listener/extractor module 306 periodically checks the inbox of an email address assigned to the print request handler 102 for incoming emails or reacts to the event of receipt of an incoming email. Upon detection of an incoming email the email listener/extractor module 306 extracts the document or data that is requested to be printed from a print request that is received in the form of an email. This document or data may be included in the body of the email. In this case, the data to be printed is extracted from the body of the email and formed into a file which is provided to the converter module 312. The document to be printed may be provided as an attachment to the email. In this case, the attachment is retrieved and each attached document is provided to the converter module 312. The email listener/extractor 306/314 also extracts additional information included with the print request, including printer information, authentication information, print options information, and/or user location information.

The FTP server module 308 includes software for handling print requests which were transmitted to the print request handler 102 using FTP. The FTP server module 308 may include commercially available software, for example Apache FTP server, for receiving and parsing messages sent via FTP, and further includes software for extracting the authorization information, the printer information and the document(s) to be printed from the print request, and providing the extracted authorization information to the authorization module 302, the printer information to the print streaming module 320, and the document(s) to be printed to the converter module 312.

The HTTP server module 310 includes software for handling print requests which were transmitted to the print request handler 102 using HTTP(s). The HTTP(s) server module 308 may include commercially available software, for example Apache HTTP Server, for receiving and parsing messages sent via HTTP(s), and further includes software for extracting the authorization information, the printer information and the document(s) to be printed from the print request, and providing the extracted authorization information to the authorization module 302, the printer information to the print streaming module 320, and the document(s) to be printed to the converter module 312.

The HTTP server module 310 may provide a website or a webpage which the mobile device 106 can access and through which the mobile device 106 submits a print request. The website may prompt the user for information needed for the print request, including the selected printer, print options, authentication and user location information and the document or an address to the document. The document may be uploaded to the HTTP server module 310 by the mobile device 106. All of this information may be exchanged using HTTP. The print request handler 102 may be web services enabled, e.g., including a SOAP server, where the print request handler 102 has the ability to receive and parse SOAP messages. For example, when the print request is in the form of a SOAP message, the HTTP server modules 308 and 310 may include a web services module that parses the SOAP message and extracts the document(s) to be printed and the authentication, print options, selected printer and user location information. The document(s) and information are provided to the proper modules as described above with respect to the FTP and HTTP server modules 308 and 310.

The converter module 312 receives a document (or several documents) that were extracted from the print request and are requested to be printed. The converter module 312 converts the document into a printer ready format (PRF), such as PDF. This may be done using commercial conversion software, such as Aspose™, which may be able to infer the input document type by reading its content or looking at its suffix. The converter module 312 passes a location of the input document (e.g., the URL for the document) and the requested output format for the document (e.g., PDF). The commercial conversion software converts the input document into a document having the requested output format. The converter module 312 may include a commercially available converter such as Nuance™, OPenOffice, XIPS and Adobe™. Upon successful conversion, the converter module 312 forwards the converted printer ready documents to the print streaming module 320. Performance of the conversion to a printer ready format by the print request handler 102 increases versatility of the network system 100 by enabling a user to request the printing of a document on any printer, regardless of whether the printer has conversion capabilities. Furthermore, printers with conversion capabilities are typically limited to only specific types of conversions, such as the conversion of specifically formatted photographs to printer ready format. Here, the conversion module can be configured to handle many different kinds of conversions and to be updatable for handling newly available kinds of conversions in order that the document to be printed can be of any genre (e.g., photograph, office document, image, graphics, etc.) and any accessible printer device 104 may be selected.

The print selector module 316 is only used when the print request does not specify printer information for a selected printer device 104 to be used. The print selector module 316 selects a printer device 104 from the at least one printer 104 that is accessible to the print request handler 102. The selection of the print device 104 may be based, for example, on the type of document being printed (e.g., photograph, office document, graphics), the printing instruction (e.g., duplex, paper size, paper type), the accessible printer devices' capabilities, the availability of the printer devices, and/or the location of the printer devices relative to the location of the user based on the user location information, etc, The identification of the selected printer and/or its hostname or IP address is provided to the print streaming module 320. Furthermore, a message is transmitted from the print request handler 102 to the mobile device 106 to inform the user of the mobile device 106 about which printer device 104 has been selected to print the document. The print selector module 316 may implement advanced features, such as automatic printer discovery and printer locator features described in U.S. patent application Ser. No. 12/557,166, filed on Sep. 10, 2009, which is herein incorporated by reference in its entirety.

In one embodiment, the print request handler 102 may include a SOAP client module 318 for generating a SOAP message that includes the converted document(s) that correspond to a print request, or a link, such as a URL, to the document. The SOAP message further includes the authentication, printing instruction, selected printer and user location information that correspond to the print request. The SOAP message is provided to the print streaming module 320 for transmission to the selected printer device 104.

The print streaming module 320 streams the printer ready documents to be printed and the print options information to the selected printer device 104, where the selected printer device 104 is based on the printer information included with the print request. If no printer information is provided with the print request the selected printer device 104 is based on the output from the print selector module or on a default printer. The printer information identifies the selected printer device 104 and is used by the streaming module 320 to send the printer ready document(s) and print options information to the selected printer device 104. If execution of the print request is not successful, the print streaming module 320 sends the user a message to the mobile device 106 indicating that a failure or error has occurred. Transmission of messages by the print request handler 102 to the mobile device 106 may include sending SMS message, email messages or the like.

When the SOAP client module 318 has generated a SOAP message, the SOAP message is streamed to the selected printer device 104. The printer ready document(s) or SOAP message are provided to the selected printer device 104 e.g., via a serial or parallel interface on the printer device 104, which may be wired or wireless, or via a TCP/IP port on the printer device 104, such as TCP port 9100 on the printer device 104. Where the TCP port 9100 is used, the print request handler 102 may provide data to printed to the selected printer device 104 without having a driver for the printer device 104 installed on the print request handler 104. This increases the versatility of the print request handler 104 by allowing it to send print requests to printer devices 104 for which it does not have a driver installed, and conserves the time and energy consumed by installing and updating printer drivers.

It is envisioned that the print request handler 102 might request information from the mobile device 106 or the mobile device user, such as by prompting the user to enter information. For example, if a requested selected printer 104 is not available, the print selector module 316 may request the user to select an alternative printer 104. In this case, the user or mobile device 106 would respond with the requested information.

The accounting module 322 tracks information related to print requests handled by the print request handler 102, such as the quantity, size and complexity of the documents to be printed and the identities of users or mobile devices generating print requests. This information may be used for a variety of purposes, such as system usage analysis and for billing users or owners of mobile devices 106 in accordance with usage of the network system for printing documents from mobile devices 106.

The print request handler 102 may be configured as a server or may be hosted on a distributed peer-to-peer (p2p) atmosphere. In another embodiment, the print request handler 102 may be embedded in a printer device 104.

In one embodiment, the printer device 104 is a conventional printer device that includes a native conventional controller for receiving print requests and controlling the printer device to print a document according to print options information. The document and print options information are included with the print request which is received from the print request handler 102 via the printer device's communication port 144.

In another embodiment, the print request handler 102, or a portion thereof, is embedded in the printer device 104. In this embodiment, the printer device 104 is provided with at least one software module for parsing a print request received directly from the mobile device 106, extracting the document(s) to be printed and print options information from the parsed print request, and/or performing a conversion on the document(s) to be printed into a printer ready format.

The printer device 102 may be provided with wireless communication capabilities, e.g., built-in Bluetooth, Wi-Fi, or Ethernet capabilities for receiving print requests. In this embodiment, when the print request handler is entirely embedded with the printer device 104, the print requests may be received directly from a mobile device 106.

Additionally, the printer device 102 may be web service enabled for receiving and parsing received SOAP message and printing the associated document(s), whether they are contained in binary form with the SOAP message, or are retrieved from an address, e.g., URL, specified in the SOAP message. The SOAP message may be received directly from the mobile device 106 or from the print request handler 102, depending on the embodiment used.

In operation, in one embodiment in which the print request is sent from the mobile device 106 to the print request handler 102 in the form of an email message, the user of the mobile device 106 opens an email application that is native to the mobile device 106. Opening an application refers to actuating an actuator, such as a hard or soft button or the like, that causes the application to be executed. A hard button is a hardware button provided with the mobile device 106 that the user can physically actuate, and a soft button is a displayed element, such as an icon, textual name, or other graphic that is displayed, e.g., on a GUI, menu, or the like, that a user can select by using a UID provided with the mobile device 106.

The email application displays (e.g., via a menu or GUI) to the user at least one action option that the user can select, such as by actuating an actuator, as described above, which requests the application to perform an action. In one embodiment, the action options includes an option entitled “Print via QR Code,” which instructs the application to prompt the user to take a picture of a quick response code (“QR Code™) associated with a printer device 104 that the user has selected to use for printing a document. A QR Code is a two-dimensional optical code that stores encoded information, which in this case is an identification code for the selected printer device 104. The present disclosure is not limited to using a QR Code, but may use any optical code, such as a High Capacity Color Barcode.

Once the user captures an image of the selected printer device's 104 QR Code by taking a picture of the QR Code, a QR Code decoder application is activated (this activation may be activated, for example, by the email application, another application (e.g., a camera application) and/or a user action) for decoding the captured QR Code. The email application initiates composing a new email message, optionally uses the decoded QR Code to retrieve from a database storing printer information an alphanumeric name and/or an address, such as a host name or IP address, associated with the selected printer device 104 that is identified by the QR Code, and inserts the retrieved name or address into the new email message. Alternatively, the decoded QR Code (e.g., in binary, hexadecimal or decimal form), may be inserted directly into the new email message.

While some steps described above and below are described as being performed automatically by an application, the disclosure is not limited there to, and the steps may be performed manually by user actions. For example, the email application may be a conventional native email application that does not prompt the user to capture a QR-Code or enter information related to printing from the mobile device 106. The user composes a new email message manually with all of the necessary information. The user manually formulates the email printer request by entering a printer host name or address (e.g., IP address) associated with the printer device 104 selected by the user e.g., by inserting it into a particular field of the new email message (e.g., cc field, display name field, body of the email message, etc.) and in a particular fashion so that the print request handler 102 can retrieve it properly.

When the printer device address is inserted into the email message it may be inserted into a selected field (e.g., cc field, display name field, body of the email message, etc.) and/or in a selected fashion. The print request handler 102 will retrieve the selected printer device address from the email message at a later stage. In the present example, an email address for the print request handler 102 is inserted into a destination email address field of the new email message, and the selected printer device's 104 host name or IP address is inserted into the display name field.

The inclusion or insertion of each piece of information, including the printer device address, with the new email message is done in a predetermined matter, e.g., by inserting it into a particular field of the new email message (e.g., cc field, display name field, body of the email message, etc.) and in a particular fashion, such as in a particular order, and or by delimiting the information by a selected character to indicate so that the print request handler 102 can retrieve each piece of information properly.

The user includes the document(s) to be printed with the email message in a selected fashion, such that the print request handler 102 will know from where to retrieve the document(s) from the email message. For example, the document(s) may be provided as an attachment to the email message or may be provided in the body of the email message. Additional information, including printing instruction and user location information is provided with the email message in a selected fashion so that the print request handler 102 will know from where to retrieve each piece of information. A GPS system integrated or interfaced with the mobile device 106 may automatically provide the user location information and insert it into the new email message. Otherwise, the user can manually insert the user location information (e.g., read off of an independent GPS system, or entered using a predetermined code system describing the user location, such as by room location) into the new email message in a selected field and/or in a selected fashion.

The user may be prompted by the email application to select print options information, such as from a menu, and the selected print options may be entered into the new email message in a selected field and/or in a selected fashion. The email application may enter the selected print options into the new email message in a selected fashion so that the print request handler 102 will know from where to retrieve the print options information. Otherwise, the user can manually insert the print options information into the new email message in a selected field and/or in a selected fashion using a predetermined language and/or syntax that the print request handler 102 will recognize.

Once the email message is composed and all of the information is included with or inserted into the email message as described above, the email message is sent to the print request handler 102. The email listener module 314 receives and retrieves the email message and provides the email message to the email extractor 306 which extracts the information from and the document(s) to be printed from the email message, using knowledge of the particular fields and the particular fashion by which each piece of information is included with or inserted into the email message.

In operation, in another embodiment in which the print request is transmitted using FTP or HTTP, the print request transmitter module 202 of the mobile device 106 gathers information entered by the user or gathered from to other devices, generates the print request by integrating the gathered information into the print request, and transmits the print request to the print request handler 102 via FTP or HTTP. This may include prompting the user to capture the QR Code of the selected printer device by taking a picture of it or to manually enter the printer information (e.g., hostname or IP address), prompting the user to manually enter the user location, prompting the user to enter print options information (e.g., by presenting a GUI with a menu or form for the user to make selections from) and prompting the user to select the document(s) to be printed (e.g., by allowing the user to browse through files and select a file). Where the QR Code is captured, the optional optical code decoder module 204 decodes the printer ID code from the captured code, accesses the database to retrieve printer information corresponding to the decoded printer ID code, and provides the information to the print request transmitter module 202 for integrating the information into the print request. Additionally, the print request transmitter module 202 may retrieve the user location information from a GPS device and integrate the location information into the print request.

In summary, a user of a mobile device 106 may select a printer to print a document and transmit the document for printing, where the document may be any type of document or file. Once the user submits the print request from the mobile device 106 (which might be done interactively with the mobile device user and/or the mobile device 106) the mobile device user and the mobile device 106 do not have to take any further actions for the print job requested to be executed. The print request submitted by the mobile device 106 is handled by the print request handler 102, but this may be transparent to the user of the mobile device 106. From the user's perspective, after transmitting the print request from the mobile device 106 the document is printed on the printer device that the user selected. If the user did not select a printer, the document may be printed by a default printer or a printer selected by the print request handler 102, and the print request handler 102 may notify the mobile device as to printer that is printing the document.

The print request handler 102 automatically handles authentication of the user or mobile device 106 and conversion of the document to be printed into a printer ready format. The print request handler 102 may automatically couple with a selected printer of a plurality of printer devices 104 via a socket connection, e.g., on TCP port 9100 of the selected printer device 104, or by a communication port by sending a SOAP message using WS-Print protocols, all without the need for using any printer drivers. The print request handler 102 automatically provides the converted document(s) to be printed to the selected printer device 104 with print options information for printing thereof. It is not necessary for the printer device 104 to have wireless capabilities, although this is not a limitation, and the printer may have wireless capabilities.

The receiving of the print request, prompting the mobile device user or the mobile device 106 for additional information if needed, and the processing of the print request, including converting the document to printer ready format and streaming the document to a selected printer using the print options provided by the print request, is all done automatically by the print request handler 102. This means that human intervention is not needed at the print request handler end 102 to receive or process the print request.

The disclosed solution for submitting print requests from a mobile device 106 may be deployed in an enterprise environment, where the network 108, the print request handler 102 and the plurality of printer devices 104 are included in the enterprise environment, and the mobile device 1006 enters the enterprise environment conditional upon authorization. This authorization may be handled by the print request handler 102. When a firewall is provided to secure the enterprise environment, the print request may remain within the protection of the firewall at all times, including from transmission from the mobile device 106, to receipt by the print request handler 102, to execution of the print request by the printing device 104 that was selected to print the print request.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A processing system for handling print requests from a mobile device, comprising:
a tangible processor;
a memory with instructions to be executed by the tangible processor for:
receiving a print request from a mobile device to print a document;
converting the document into a printer ready format; and
submitting the document to a selected one of at least two printer devices which are in data communication with the tangible processor for printing of the document, wherein the receiving, converting and submitting are performed without intervention by a user of the tangible processor.

2. The processing system according to claim 1, wherein the document is submitted by the tangible processor to the selected printer device without using a printer driver.

3. The processing system according to claim 1, wherein the print request is an email message and includes the document in a non-printer ready format, and the software module is further executed by the tangible processor for extracting the document from the email message.

4. The processing system according to claim 1, wherein the print request is sent by the mobile device using at least one of FTP and HTTP, and includes the document in a non-printer ready format, and the software module is further executed by the tangible processor for extracting the document from the print request.

5. The processing system according to claim 1, wherein the software module is further executed by the tangible processor for authenticating at least one of the mobile device and the user of the mobile device before submitting the document to the selected printer device.

6. The processing system according to claim 1, wherein the tangible processor is in wired communication with the selected printer device for submitting the document to the selected printer device.

7. The processing system according to claim 1, wherein the document includes at least one of a word processing document, a spreadsheet document, a photo document, a presentation document, and includes data selected from at least one of alphanumeric data, image data, and graphics data.

8. The processing system according to claim 1, wherein the document is secured behind a firewall from the time that the print request is submitted by the mobile device until the document is submitted to the selected printer device for printing thereof.

9. A method for a mobile device to submit a document for printing thereof, the method comprising:
receiving by a hardware processor a print request from a mobile device to print a document;
converting by the hardware processor the document into a printer ready format; and
submitting by the hardware processor the document to a selected printer device of at least two printer devices that the hardware processor is in data communication with for printing of the document, wherein the receiving, converting and submitting are performed without intervention by a user of the hardware processor.

10. The method according to claim 9, wherein the print request is an email message and includes the document in a non-printer ready format, and the method further includes extracting by the hardware processor the document from the email message.

11. The method according to claim 9, wherein the print request is sent by the mobile device using at least one of FTP and HTTP, and includes the document in a non-printer ready format, and the method further includes extracting by the hardware processor the document from the print request.

12. The method according to claim 9, wherein the document includes at least one of a word processing document, a spreadsheet document, a photo document, a presentation document, and includes data selected from at least one of alphanumeric data, image data, and graphics data.

13. A mobile device comprising:
a processor assembly including at least one hardware processor accessing at least one data storage device;
a software module executable by the processor assembly for:
retrieving document information, including one of a document or an address for the document, from the accessible at least one storage device;
selecting a printer device from a plurality of printer devices available for printing the document;
generating a print request to print the document, wherein the print request includes the document information and information identifying the selected printer device; and
transmitting the print request to a print request handler, upon which the document is printed by the selected printer device.

14. The mobile device according to claim 13, wherein the print request is an email message.

15. The mobile device according to claim 13, wherein the print request is sent by the mobile device using at least one of FTP and HTTP.

16. The mobile device according to claim 13, wherein the document includes at least one of a word processing document, a spreadsheet document, a photo document, a presentation document, and includes data selected from at least one of alphanumeric data, image data, and graphics data.

17. The mobile device according to claim 13, wherein the processor assembly receives a decoded printer identification code from an optical code decoder device based on the decoding of an acquired optical code associated with the selected printer device, and the information identifying the selected printer device includes the decoded printer identification code.

18. The mobile device according to claim 17, wherein the mobile device further comprises an optical code reader, including an imager for acquiring the optical code and the optical code decoder device.

19. A computer-readable medium storing a series of programmable instructions configured for execution by at least one hardware processor for performing a method for submitting a document for printing thereof by a mobile device comprising the steps of
receiving a print request from a mobile device to print a document;
converting the document into a printer ready format; and
submitting the document to a selected printer device of at least two printer devices for printing of the document, wherein the steps are performed without intervention by a user of the at least one hardware processor.

20. The computer-readable medium according to claim 19, wherein the document includes at least one of a word processing document, a spreadsheet document, a photo document, a presentation document, and includes data selected from at least one of alphanumeric data, image data, and graphics data.

21. The mobile device according to claim 13, wherein the selecting a printer device includes at least one of manually entering information identifying the printer device and selecting the printer device from, a list of printers provided via the mobile device.
